(19) United States
(12) Patent Application Publication
(10) Pub. No.: US 2005/0131698 A1
(43) Pub. Date: Jun. 16, 2005

(54) System, method, and storage medium for generating speech generation commands associated with computer readable information

(76) Inventor: Steven Tischer, Atlanta, GA (US)

Correspondence Address: Philmore H. Colburn II;Cantor Colburn LLP, 55 Griffin Road South, Bloomfield, CT, 06002, US

(21) Appl. No.: 10/736,440

(22) Filed: Dec. 15, 2003

(51) Int. Cl. G10L 13/08; G10L 21/00

(52) U.S. Cl. 704/270; 704/260

(57) ABSTRACT

A system and method for generating a collection of speech generation commands associated with computer readable information is provided. The method includes partitioning the computer readable information into at least first and second portions of computer readable information. The method further includes generating a first collection of speech generation commands based on the first portion of computer readable information in a first computer. Finally, the method includes generating a second collection of speech generation commands based on the second portion of computer readable information in a second computer.

### FIELD OF INVENTION

The present invention relates to a system and a method for generating speech generation commands associated with computer readable information.

### BACKGROUND

Known text-to-speech (TSS) systems have translated computer readable information to speech. For example, an email message text message may be translated to speech commands in a computer server. Further, the computer server can perform computational analysis on the text message to determine if portions of the text message match speech samples stored in the computer server to produce audio sounds using the matched speech samples.

Further, computer readable information, such as ASCII textual messages, may represent words that can be described using phonemes or multi-phonemes. A phoneme is the smallest phonetic unit in a language that is capable of conveying a distinction in meaning in a language, as the “m” in “mat” in English. A multi-phoneme comprises two or more phonemes. Text-to-speech systems that utilize multi-phonemes generally produce speech that more closely replicates human speech as compared to systems that only utilize phonemes. Multi-phonemes replicate human speech more closely than phonemes because multi-phonemes comprise longer word utterances that that are played back verbatim to a listener.

When computer readable information includes words having multi-phonemes, the computational requirements of the computer may become relatively large when analyzing the word combinations during text-to-speech translation. As a result, the computer may not be able to translate the textual email messages to speech in a desirable time period. In particular, when the computer computing capacity reaches its maximum level, the speech pattern generated by the computer may become delayed or discontinuous which is undesirable for users desiring to listen to their email messages in a predetermined “life-like” voice. Thus, there is a need for the distributed processing of text-to-speech translations that can reduce the processing time required for the text-to-speech translations.

### SUMMARY OF THE INVENTION

The foregoing problems and disadvantages are overcome by a system and a method for generating speech generation commands associated with computer readable information.

A system for generating a collection of speech generation commands associated with computer readable information is provided. The system includes a first computer configured to receive the computer readable information and to partition the computer readable information into at least first and second portions of computer readable information. The first computer is further configured to generate a first collection of speech generation commands based on the first portion of computer readable information. The system further includes a second computer configured to receive the second portion of computer readable information from the first computer and to generate a second collection of speech generation commands based on the second portion of computer readable information. The first computer is further configured to receive the second collection of speech generation commands from the second computer and to generate a third collection of speech generation commands based on the first and second collection of speech generating commands.

A method for generating a collection of speech generation commands associated with computer readable information is provided. The method includes partitioning the computer readable information into at least first and second portions of computer readable information. The method further includes generating a first collection of speech generation commands based on the first portion of computer readable information in a first computer. Finally, the method includes generating a second collection of speech generation commands based on the second portion of computer readable information in a second computer.

A storage medium encoded with machine-readable computer program code for generating a collection of speech generation commands associated with computer readable information is provided. The storage medium including instructions for causing at least one system element to implement a method comprising: partitioning the computer readable information into at least first and second portions of computer readable information; generating a first collection of speech generation commands based on the first portion of computer readable information in a first computer; and,
generating a second collection of speech generation commands based on the second portion of computer readable information in a second computer.

Other systems, methods, and computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic of a system for generating a collection of speech generation commands associated with computer readable information.

FIG. 2 is a schematic of an exemplary email message containing computer readable information.

FIG. 3 is a schematic of an exemplary data set sent from the primary TTS computer to a secondary TTS computer.

FIG. 4 is a schematic of an exemplary data set sent from the secondary TTS computer to a primary TTS computer.

FIG. 5 is a schematic of a voice file that can be stored in the primary TTS computer, the secondary TTS computer, and a cell phone.

FIG. 6 is a schematic of a data set containing a collection of speech generation commands.

FIGS. 7A-7D are a flowchart of a method for generating speech generation commands.

### DETAILED DESCRIPTION OF THE INVENTION

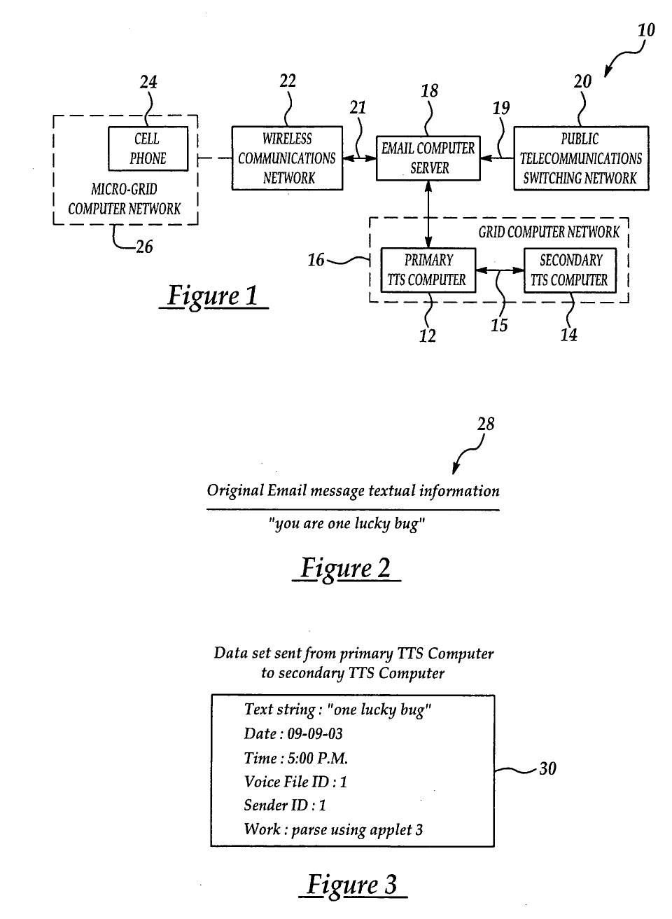

Referring to the drawings, identical reference numerals represent identical components in the various views. Referring to FIG. 1, a system 10 for generating a collection of speech generation commands associated with computer readable information is illustrated. System 10 includes a primary TTS computer 12, a secondary TTS computer 14, a grid computer network 16, an e-mail computer server 18, a public telecommunication switching network 20, a wireless communications network 22, a cell phone 24, and a micro-grid computer network 26.

Primary TTS computer 12 is provided to distribute the tasks of generating speech generation commands associated with computer readable information to more than one computer. In particular, computer 12 may receive an e-mail text message from e-mail computer server 18 that a user may want to hear orally through a cell phone 24. Referring to FIG. 2, for example, computer 12 may receive the e-mail message “you are one lucky bug”. Computer 12 may then determine the computer resources available within the grid computer network 16 for translating the textual e-mail information into a collection of speech generation commands. As shown, primary TTS computer 12 communicates with a secondary TTS computer 14 through a communication channel 15. Primary TTS computer 12 may include a memory (not shown) for storing a voice file 34 utilized for generating speech generation commands as will be explained in greater detail below.

Secondary TTS computer is provided to assist primary TTS computer 12 in translating computer readable information, such as textual e-mail information, into speech generation commands. Secondary TTS computer 14 may include a memory (not shown) for storing a voice file 34 utilized for generating speech generation commands as will be explained in greater detail below.

As shown, primary TTS computer 12 and secondary TTS computer 14 may be part of a grid computer network 16. Grid computer network 16 may utilize known communication protocols for allowing primary TTS computer 12 to communicate with secondary TTS computer 14 and other computers (not shown) capable of generating speech generation commands.

E-mail computer server 18 is conventional in the art and is provided to store e-mail messages received from public telecommunication switching network 20 and wireless communications network 22. Computer server 18 is further provided to route signals corresponding to either (i) voice generation commands, or (ii) auditory speech via wireless communications network 22 to cell phone 24. E-mail computer server 18 communicates with network 20 via a communication channel 19. E-mail computer server 18 communicates with wireless communication network 22 via communication channel 21.

Wireless communications network 22 is conventional in the art and is provided to transmit information signals between cell phone 24 and e-mail computer server 18. Network 22 may communicate with cell phone 24 via radio frequency (RF) signals as known to those skilled in the art.

Cell phone 24 is provided to generate auditory speech from signals received from wireless communications network 22 corresponding to either: (i) auditory speech, or (ii) speech generation commands. Cell phone 24 may include a memory (not shown) for storing a voice file 34 utilized for generating auditory speech as will be explained in greater detail below.

As shown, cell phone 24 may be part of a micro-grid computer network 26. Micro-grid computer network 26 may include cell phone 24 and a plurality of other handheld computer devices having a standardized communications protocol to facilitate communication between the devices in network 26. For example micro-grid computer network 26 may include a personal data assistant (not shown) or other cell phones in close proximity to cell phone 24 having the capability of generating speech generation commands.

Before providing a detailed description of the method for generating speech generation commands, a description of a voice file 34 will be described. In particular, voice file 34 may be stored in primary TTS computer 12, secondary TTS computer 14, and cell phone 24 for either (i) generating a collection of speech generation commands, or (ii) generating auditory speech based upon the speech generation commands as will be explained in greater detail below. As shown, voice file 34 includes a plurality of records each having the following attributes: (i) textual words, (ii) a speech generation command, (iii) phonemes or multi-phonemes, (iv) and digital speech samples. The “textual words” attribute corresponds to words represented as ASCII text. For example, a textual word attribute could comprise “you are”. As discussed above, a phoneme is the smallest phonetic unit in a language that is capable of conveying a distinction in meaning in a language, as the “m” in “mat” in English. A multi-phoneme comprises two or more phonemes. For example a multi-phoneme corresponding to the textual words “you are” may comprise “Y UW AA R.” The “speech generation command” attribute corresponds to a unique numerical value associated with a unique digital speech sample attribute and a unique phoneme or multi-phoneme. For example, the speech generation command 332 corresponds to the multi-phoneme “Y UW AA R” and the digital speech sample (n1). The digital speech samples are stored voice patterns of a predetermined person speaking a predetermined word or sets of words. For example, the digital speech sample (n1) correspondence to be spoken words “you are” in the voice of a predetermined person.

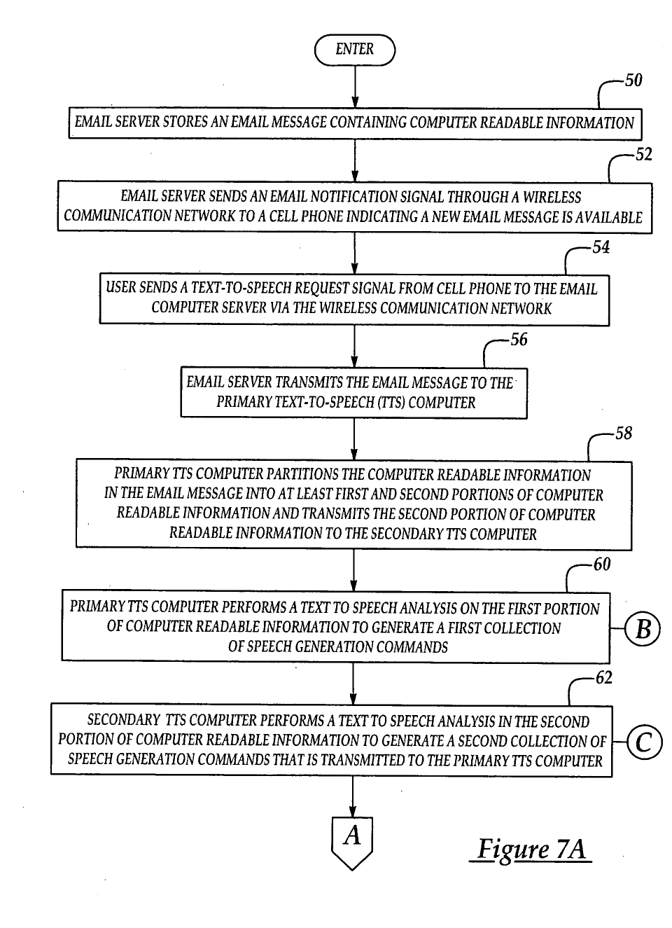

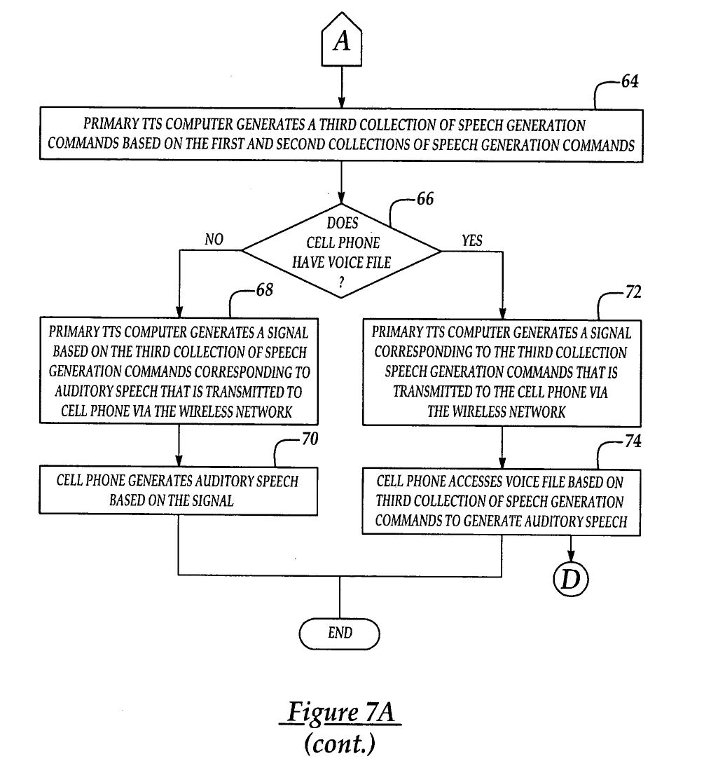

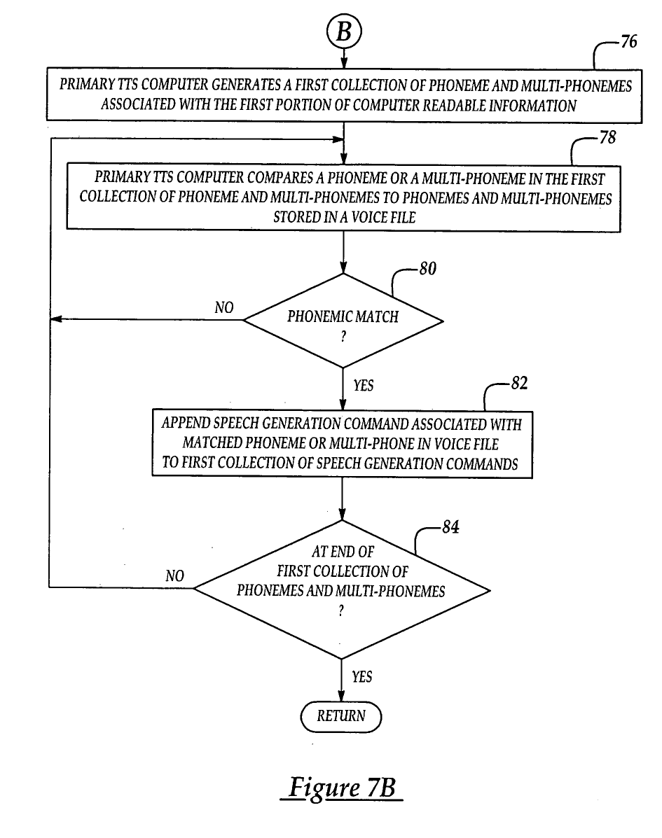

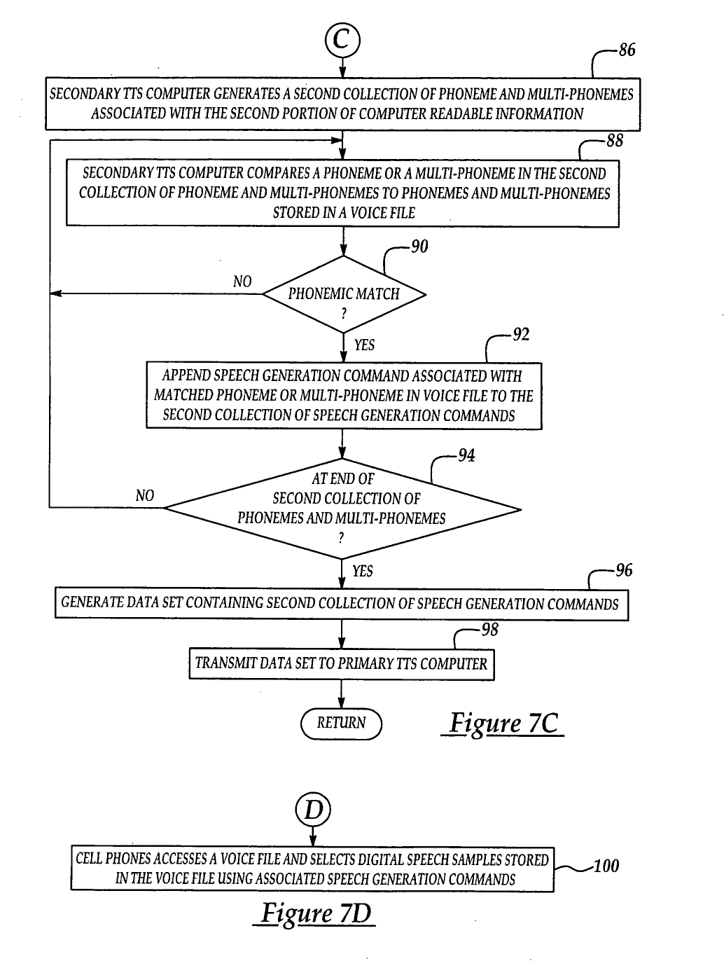

Referring to FIGS. 7A-7D a method for generating a collection of voice generation commands will now be explained. It should be noted that the following discussion presumes that a user of cell phone 24 as set up a text-to-speech service with a service provider controlling email computer server 18.

At step 50, e-mail computer server 18 stores and e-mail message containing computer readable information. For example, e-mail computer server 18 may store an e-mail textual message “you are one lucky bug”.

At step 52, email computer server 18 sends an email notification signal through wireless communications network 22 to cell phone 24 notifying the user of cell phone 24 that a new email message is available.

At step 54, a user of cell phone 24 sends a text to speech request signal from cell phone 24 to email computer server 18 via wireless communications network 22.

At step 56, email computer server 18 transmits the e-mail message to the primary TTS computer 12. Referring to FIG. 3, for example, computer server 18 may transmit a data set 30 containing the email message to primary TTS computer 12. As shown, the data set 30 may include the following attributes: (i) text string, (ii) date, (iii) time, (iv) voice file ID, (v) sender ID, (vi) and the work to be performed.

The “text string” attribute may contain the e-mail textual message. The “voice file ID” attribute may correspond to a voice file 34 stored in both primary TTS computer 12 and secondary TTS computer 14. The “sender ID” attribute may contain a communication channel for communicating with e-mail computer server 18. The “work to be performed” attribute may include tasks to be performed by primary TTS computer 12.

At step 58, primary TTS computer 12 partitions the computer readable information in the email message into at least first and second portions of computer readable information and transmits the second portion of computer readable information to secondary TTS computer 14. For example, computer 12 may partition and email message “you are one lucky bug” into a first portion “you are” and a second portion “one lucky bug”. Further, computer 12 may transmit the second portion “one lucky bug” to secondary TTS computer 14 for further processing.

At step 60, primary TTS computer 12 performs a text-to-speech analysis on the first portion of computer readable information to generate a first collection of speech generation commands.

Referring to FIG. 7B, the step 60 may be performed utilizing steps 76-84. At step 76, primary TTS computer 12 generates a first collection of phonemes and multi-phonemes associated with the first portion of textual information, using known TTS algorithms. For example, computer 12 may generate a multi-phoneme “Y UW AA R” associated with the first portion of textual information “you are”.

At step 78, primary TTS computer 12 compares a phoneme or multi-phoneme in the first collection of phonemes and multi-phonemes to phonemes and multi-phonemes stored in voice file 34. For example, computer 12 may compare a multi-phoneme “Y UW AA R” generated from the text “you are” to each of phoneme and multi-phoneme stored in voice file 34. It should be noted that primary TTS computer 12 may first compare multi-phonemes in the first collection to multi-phonemes in voice file 34, and thereafter compare phonemes in the first collection to phonemes in voice file 34.

At step 80, primary TTS computer 12 can determine whether there is a phonemic match between a first collection of phoneme and multi-phonemes and one or more phoneme or multi-phoneme stored in voice file 34. For example, computer 12 can determine whether voice file 34 has a corresponding multi-phoneme “Y UW AA R” matching the first collection of multi-phoneme “Y UW AA R”.

At step 82, primary TTS computer 12 can append one or more speech generation commands associated with the matched phoneme or multi-phoneme in voice file 34 to a first collection of speech generation commands. For example, when TTS computer 12 determines that the matched multi-phoneme comprises “Y UW AA R”, computer 12 can append the speech generation command 332 to a first collection of speech generation commands. In particular, referring to FIG. 6, computer 12 can generate a data set 36 that includes a speech generation command 332.

At step 84, primary TTS computer 12 determines whether additional phonemes or multi-phonemes generated from the textual e-mail message need to be compared to phonemes and multi-phonemes in voice file 34. If the value of step 84 equals “yes”, the method advances to step 62. Otherwise, if the value of step 84 equals “no”, the method advances to step 78 to perform further comparisons between phonemes and multi-phonemes related to the textual message to phonemes and multi-phonemes in voice file 34.

Referring again to FIG. 7A, a step 62 is performed after the step 60. At step 62, secondary TTS computer 14 performs text-to-speech analysis on the second portion of computer readable information to generate a second collection of speech generation commands that are transmitted to primary TTS computer 12. Referring to FIG. 7c, the step 62 may be performed utilizing steps 86-98.

At step 86, secondary TTS computer 14 generates a second collection of phonemes and multi-phonemes associated with the second portion of textual information, using known algorithms. For example, computer 14 may generate a multi-phoneme “W AH N L AH KIY B AH G” associated with the second portion of textual information “one lucky bug”.

At step 88, secondary TTS computer 14 compares a phoneme or multi-phoneme in the second collection of phonemes and multi-phonemes to phonemes and multi-phonemes stored in voice file 34. For example, computer 14 may compare a second collection of multi-phonemes “W AH N L AH KIY B AH G” generated from the text “one lucky bug” to each of the phonemes and multi-phonemes stored in voice file 34. It should be noted that secondary TTS computer 14 may first compare multi-phonemes in the second collection to multi-phonemes in voice file 34, and thereafter compare phonemes in the second collection to phonemes in voice file 34.

At step 90, secondary TTS computer 14 can determine whether there is a phonemic match between one or more of a second collection of phoneme and multi-phonemes and one or more phonemes or multi-phonemes stored in voice file 34. For example, computer 12 can determine voice file 34 has a corresponding multi-phoneme “W AH N L AH KIY B AH G” matching the second collection of multi-phonemes “W AH N L AH KIY B AH G”.

At step 92, secondary TTS computer 14 can append one or more speech generation commands associated with the matched phoneme or multi-phoneme in voice file 34 to a second collection of speech generation commands. For example, when computer 14 determines that the matched multi-phoneme comprises “W AH N L AH KIY B AH G”, computer 12 can append the speech generation command (406) to a second collection of speech generation commands.

At step 94, secondary TTS computer 14 determines whether there are additional phonemes or multi-phonemes generated from the second portion of the computer readable information to be compared to phonemes and multi-phonemes in voice file 34. If the value of step 94 equals “yes”, the method advances to step 96. Otherwise, if the value of step 94 equals “no”, the method advances to step 88 to perform further comparisons between phonemes and multi-phonemes of the textual message to phonemes and multi-phonemes in voice file 34.

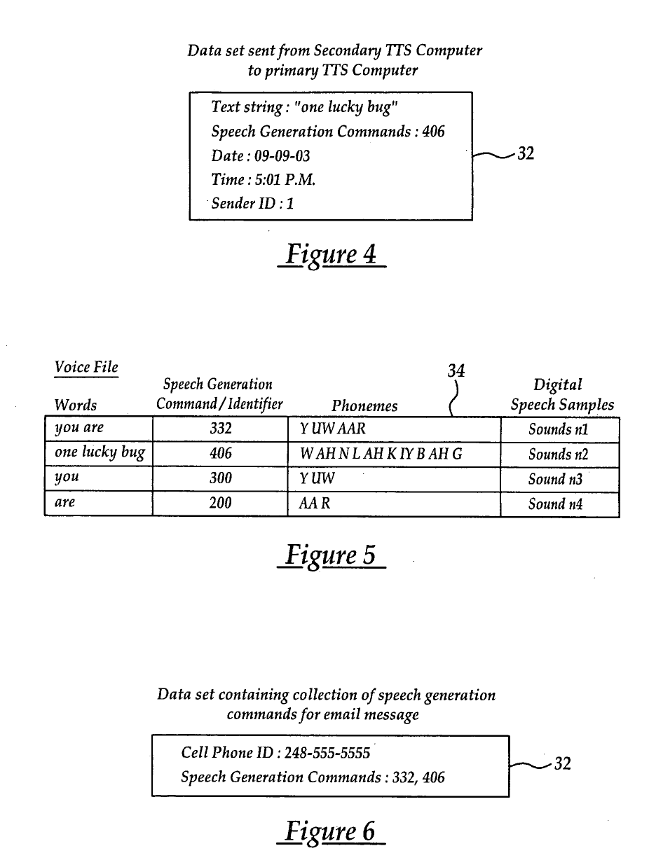

At step 96, secondary TTS computer 14 generates a data set containing the second collection of speech generation commands. In particular, referring to FIG. 4, computer 14 can generate a data set 32 that includes a speech generation command (406) corresponding to the multi-phoneme “W AH N L AH KIY B AH G”.

Next step 98, secondary TTS computer 14 transmits data set 32 to primary TTS computer 12. After step 98, the method advances to step 64.

Referring to FIG. 7A, at step 64, primary TTS computer 12 generates a third collection of speech generation commands based on the first and second collections of speech generation commands generated by computers 12,14 respectively.

At step 66, primary TTS computer 12 queries e-mail computer server 18 to determine whether cell phone 24 has a voice file 34 stored in a memory (not shown) of cell phone 24. In an alternate system embodiment (not shown), TSS computer 12 could directly query cell phone 24 to determine whether cell phone 24 has voice file 34 stored in a memory. If the value of step 66 equals “yes”, the steps 68, 70 are performed. Otherwise, the steps 72, 74 are performed.

At step 68, primary TTS computer 12 generates a signal based on the third collection of speech generation commands corresponding to auditory speech that is transmitted to cell phone 24 via email computer server 18 and wireless communications network 22.

Next at step 70, cell phone 24 generates auditory speech based on the signal received from primary TTS computer 12.

Referring again to step 66, when the determination indicates the cell phone 24 does have voice file 34 stored in a memory therein, the method advances to step 72. At step 72 primary TTS computer 12 generates a signal corresponding to the third collection of speech generation commands that is transmitted to cell phone 24 via e-mail computer server 18 and wireless communications network 22.

Next at step 74, cell phone 24 accesses voice file 34 based on the third collection of speech generation commands to generate auditory speech. In particular, step 74 may be implemented by a step 100. At step 100, cell phone 24 accesses voice file 34 and selects digital speech samples stored in voice file 34 using the received speech generation commands. For example, cell phone 24 can receive speech generation commands 332, 406 from computer 12 and thereafter access digital speech samples (n1) (n2) from voice file 34 to generate the spoken words “you are one lucky bug”.

The present system and method for generating a collection of speech generation commands associated with computer readable information provides a substantial advantage over known systems and methods. In particular, the system can distribute the computer processing associated with translating computer readable information to speech generation commands to multiple computers. Accordingly, computer readable information containing numerous phonemes and multi-phonemes can be processed rapidly in two or more computers to provide a “lifelike” speech pattern associated with the computer readable information. For example, the inventive system and method can be utilized with a voice-mail system to allow a user to hear their e-mail messages read in one or more predetermined “life-like” voices. For example, a user could have a single e-mail message read to them using both the voice of Humphrey Bogart for one or more of the words in the e-mail message and the voice of John Wayne for one or more of the words in the e-mail message, which is computationally intensive.

As described above, the present invention can be embodied in the form of computer-implemented processes and apparatuses for practicing those processes. In an exemplary embodiment, the invention is embodied in computer program code executed by one or more network elements. The present invention may be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A system for generating a collection of speech generation commands associated with computer readable information, comprising:
a first computer configured to receive the computer readable information and to partition the computer readable information into at least first and second portions of computer readable information, the first computer further configured to generate a first collection of speech generation commands based on the first portion of computer readable information; and,
a second computer configured to receive the second portion of computer readable information from the first computer and to generate a second collection of speech generation commands based on the second portion of computer readable information, the first computer is further configured to receive the second collection of speech generation commands from the second computer and to generate a third collection of speech generation commands based on the first and second collection of speech generating commands.

2. The system of claim 1 wherein the first computer generates signals based on the third collection of speech generation commands.

3. The system of claim 2 further comprising both a wireless communication network operatively communicating with the first computer and a cellular phone operatively communicating with the wireless communication network, wherein the signals generated by the first computer are transmitted through the wireless communication network to the cellular phone.

4. The system of claim 3 wherein the signals correspond to auditory speech, the cellular phone generating auditory speech based on the received signals.

5. The system of claim 3 wherein the cellular phone includes a memory having a voice file stored therein, the voice file having a plurality of speech samples from a predetermined person, the signals received by the cellular phone corresponding to the third collection of speech generation commands, the phone accessing a predetermined set of the speech samples in the voice file based on the third collection of speech generation commands to generate auditory speech.

6. The system of claim 1 wherein the first computer further includes a memory having a voice file stored therein, the voice file having a plurality of speech samples from a predetermined person, the first collection of speech generation commands being associated with a predetermined set of the plurality of speech samples.

7. A method for generating a collection of speech generation commands associated with computer readable information, comprising:
partitioning the computer readable information into at least first and second portions of computer readable information;
generating a first collection of speech generation commands based on the first portion of computer readable information in a first computer; and,
generating a second collection of speech generation commands based on the second portion of computer readable information in a second computer.

8. The method of claim 7 wherein the first computer includes a memory storing a voice file, the voice file having a plurality of speech generation commands associated with speech samples of a predetermined person, wherein the generation of the first collection of speech generation commands includes:
generating a third collection of phoneme and multi-phonemes associated with the first portion of computer readable information;
comparing a phoneme or multi-phoneme in the third collection to phonemes and multi-phonemes stored in the voice file to determine a matched phoneme or multi-phoneme; and,
selecting a speech generation command in the voice file associated with the matched phoneme or multi-phoneme.

9. The method of claim 8 wherein the comparing of a phoneme or multi-phoneme in the third collection to phonemes and multi-phonemes stored in the voice file to determine a matched phoneme or multi-phoneme includes:
comparing a multi-phoneme in the third collection to multi-phonemes stored in the voice file; and,
comparing a phoneme in the third collection to phonemes stored in the voice file.

10. The method of claim 7 further comprising generating a third collection of speech generation commands in the first computer based on the first and second collections of speech generation commands.

11. The method of claim 7 further comprising:
generating a signal based on the first and second collections of speech generation commands corresponding to auditory speech; and,
transmitting the signal through a wireless communication network to a cellular phone.

12. The method of claim 11 further comprising generating auditory speech in the cellular phone directly based on the signal.

13. The method of claim 7 further comprising:
generating a signal corresponding to the first and second collections of speech generation commands; and,
transmitting the signal through a wireless communication network to a cellular phone.

14. The method of claim 13 wherein the cellular phone includes a memory having a voice file stored therein, the method further comprising accessing portions of the voice file based on the first and second collections of speech generation commands to generate auditory speech.

15. A storage medium encoded with machine-readable computer program code for generating a collection of speech generation commands associated with computer readable information, the storage medium including instructions for causing at least one system element to implement a method comprising:
partitioning the computer readable information into at least first and second portions of computer readable information;
generating a first collection of speech generation commands based on the first portion of computer readable information in a first computer; and,
generating a second collection of speech generation commands based on the second portion of computer readable information in a second computer.
